(19) United States
(12) Patent Application Publication
(10) Pub. No.: US 2006/0075042 A1
(43) Pub. Date: Apr. 6, 2006

(54) Extensible resource messaging between user applications and network elements in a communication network

(75) Inventors: Phil Yonghui Wang, Nepean (CA); Franco Travostino, Arlington, MA (US); Tal Lavian, Sunnyvale, CA (US)

Correspondence Address: JOHN C. GORECKI, ESQ., P.O BOX 553, CARLISLE, MA, 01741, US

(73) Assignee: Nortel Networks Limited, St. Laurent (CA)

(21) Appl. No.: 10/955,163

(22) Filed: Sep. 30, 2004

(51) Int. Cl. G06F 15/16

(52) U.S. Cl. 709/206

(57) ABSTRACT

Extensible resource messaging in a communication network is provided through creation of a flexible, extensible, and secure messaging environment. A client-server architecture may be implemented in which user applications employ messaging clients to send resource requests for network information, allocation and other operations and receive resource responses, and in which network elements, through resource agents, may use messaging servers to accept resource requests and return resource responses. Resource agents in different network domains may interact through the messaging environment and work together to fulfill resource requests. An XML-based messaging mechanism may be built with a defined message format that can provide flexible message contexts. Network resource semantics may be specified using XML schemas so that network resources are expressed as resource-specific XML elements and network updates can be implemented by updating the XML resource schemas. Secure enhancements may be realized by secure transport, message verification and other means.

### BACKGROUND

1. Field

This application relates to communication networks and, more particularly, to extensible resource messaging between user applications and network elements in a communication network.

2. Description of the Related Art

Data communication networks may include various computers, servers, routers, switches, hubs, proxies, and other devices coupled to and configured to pass data to one another. These devices will be referred to herein as “network elements,” and may provide a variety of network resources including physical resources such as communication links and bandwidths, and logical resources such as VPN (Virtual Private Network) and AAA (Authentication, Authorization and Accounting) services. Conventionally, data has been transported through the data communication networks by passing protocol data units (such as cells, frames, packets, or segments) between the network elements while utilizing one or more type of network resources. A particular protocol data unit may be handled by multiple network elements and cross multiple communication links as it travels between its source and its destination over the network.

Many user-end applications, such as grid computing, streaming media, and storage on demand, require extensive network capability to obtain access to data, computational resources, storage resources, and other types of resources that are connected in a communication network. As communication networks have evolved, the type of applications designed to run on the network have also evolved and are expected to continue to evolve. To secure access to the resources connected by the network, the applications therefore communicate with network elements to obtain network resources to meet their requirements.

Numerous protocols have been developed to allow network elements to communicate with each other and to allow applications to communicate with network elements, several of which may be used by user applications to access resources on the networks. For example, Reservation Protocol (RSVP) may be used by Internet Protocol (IP) applications in a communication network, such as a statistical multiplexing packet based network, to reserve a portion of the available bandwidth on the data transferring route through the network. Similarly, User to Network Interface (UNI) allows an application to set up a traffic path, such as an ATM virtual circuit or an optical lightpath, over an ATM or optical transport network. However, those protocols are actual network signaling protocols, and thus are defined to be used for pre-designated purposes such as to set up a network route and/or to perform link setup and teardown. Additionally, these protocols are generally defined by one or more standard bodies to enable interaction between the network elements, and are not specifically designed to handle interactions between networks and applications. As new types of network resources continue to emerge on communication networks, the manner in which resource information is obtained and the manner in which resource utilization is obtained are important aspects to fulfilling application requests.

### SUMMARY OF THE DISCLOSURE

According to an embodiment of the invention, extensible resource messaging in a communication network is provided through the creation of a flexible, extensible and secure messaging environment between user applications and network elements. User applications are represented by resource clients that request information and/or the utilization of network resources. Network elements are represented by resource agents that manage and control access to and utilization of network resources. The messaging environment is flexible, according to one embodiment of the invention, because it may be implemented as an XML-based messaging mechanism. This mechanism contains a defined XML format that can provide flexible message contexts for resource requests and responses. Thus, applications can send XML messages to request network resource reservations and network discovery queries, and networks can send XML messages to respond to the application requests.

The messaging environment is extensible, according to one embodiment of the invention, because it can introduce network resource semantics in terms of XML schemas. With the semantics, network resources can be added or removed through updating XML schemas. Thus, applications can easily use new network resources or avoid outdated network resources.

The messaging environment is secure, according to one embodiment of the invention, because it may be built using secure transport technologies, including for example, the exchange of digital signatures and certificates to authenticate the participating applications and networks or network agents. Through secure transport, messages from applications and networks may be encrypted and decrypted. Through digital identifications and certificates, applications can verify whether the networks have provided trustable information, while networks can authorize and even account resource utilization according to applications' authentication.

The messaging environment may be implemented using a client-server computer architecture in which one or more messaging servers are implemented on the network to accept requests from applications and one or more messaging clients are created for resource applications requiring access to network resources. One or more resource agents may be associated with the messaging servers to realize network resource allocations on underlying networks or network domains. Optionally, one or more of the resource agents may also work with another resource agents to allow resource allocations and information to be. obtained from other networks, with resource optimization when possible.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example of a communication network including an extensible messaging environment according to an embodiment of the invention;

FIG. 2 is a functional block diagram of the messaging environment of FIG. 1, according to an embodiment of the invention;

FIGS. 3A and 3B are functional block diagrams of XML processes for exchanging a resource request message and a resource response message between an application and a resource agent according to an embodiment of the invention;

FIG. 4 is a message format for use in the messaging environment of FIGS. 1-2 and in the processes of FIGS. 3A and 3B according to an embodiment of the invention;

FIGS. 5 and 6 are example XML schemas for use with embodiments of the invention, in which FIG. 5 is an example of a resource request schema and FIG. 6 is an example of a resource response schema;

FIG. 7 is a flow diagram illustrating a process of using the messaging environment to obtain access to network resource information and resource allocations according to an embodiment of the invention;

FIG. 8 is a functional block diagram of a user application including a messaging client according to an embodiment of the invention; and

FIG. 9 is a functional block diagram of a resource agent including a messaging stub according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

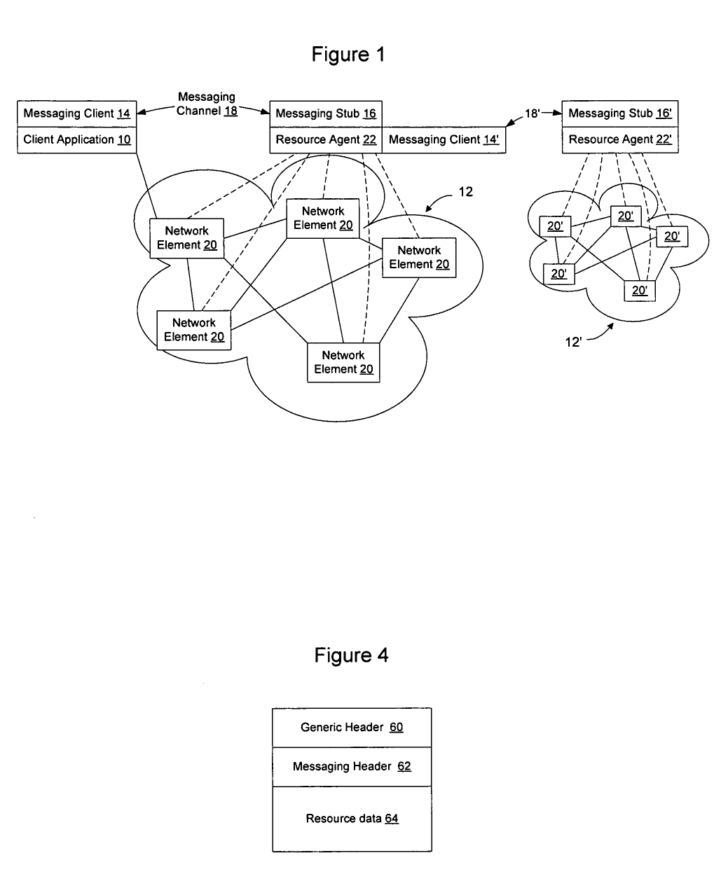

FIG. 1 illustrates an example of a communication network according to an embodiment of the invention in which a messaging environment is established to enable a client application 10 (also referred to herein as a user application or a resource application) to obtain network resource information and request resource allocations on a communication network 12. According to an embodiment of the invention, the messaging environment includes a messaging client 14, a messaging stub (also referred to herein as a messaging server) 16 and a messaging channel 18 extending between the messaging client and messaging stub to allow communications to take place between the peers of the messaging environment.

The messaging client and the messaging stub use the same message format for communications. The message format will be discussed in greater detail below, but according to one embodiment of the invention, the message format is configured to implement an extensible language such as eXtensible Markup Language (XML), to enable communications between the applications and communication network to be able to adapt with changes to the applications and changes to the network, without the creation of interdependence between these participants.

The messaging environment may include multiple messaging clients and multiple messaging stubs and the invention is not limited to an implementation of the messaging environment having any set number of clients and stubs. For example, multiple messaging stubs may be associated with a given network or network domain, or a given messaging stub may serve multiple network domains. Optionally, inter-domain exchanges may implement additional messaging environments 18′ such that the messaging stub of one messaging environment is able to participate through an associated messaging client 14′ to interface other messaging stubs 16′.

The communication network may include multiple network elements 20 connected together in a predefined or ad-hoc manner and configured to provide network services such as bandwidths over communication links to applications and network users. The invention is not limited to the particular manner in which the network elements are interconnected, the type of protocols they use to implement exchanges, route data through the network, or otherwise enable communications to take place. The invention is also not limited to the particular types of services the network elements are configured to provide on the network. For example, the communication links may be optical links, copper links, wireless links, or formed in other manners. The network elements may likewise be configured to provide optical transport services, wired data services, or wireless data services. The invention is thus not limited to use with a particular type of network element or to a particular network architecture.

One or more resource agents 22 on the network are configured to receive requests for network resources and fulfill the requests. One such resource agent is described in greater detail in a related U.S. patent application Ser. No. 10/719,225, filed Nov. 21, 2003, and entitled Method and Apparatus for Scheduling Resources on a Switched Underlay Network, the content of which is hereby incorporated by reference. As described in greater detail in that patent application, the resource agent is able to receive requests for resource allocations, interface with the network elements using native protocols in use on the network(s), and schedule resource allocations to fulfill the requests. Since the details of how resources may be obtained from a resource agent system are disclosed in greater detail in this related application, those details will not be described in greater detail herein. The messaging environment discussed in connection with embodiments of the invention herein may work with the referenced resource agent or other resource agents and the invention is not limited to an embodiment that is configured to work with the referenced resource agent.

The resource agent may be associated with a single network domain or may be associated with multiple network domains. Optionally, a messaging environment according to an embodiment of the invention may be established between resource agents of multiple domains to secure cross-domain (referred to herein as inter-domain) resource allocations. Similarly, multiple resource agents may be instantiated for the same domain to provide redundancy and to enable load sharing to take place across the several resource agents on the domain. Optionally, messaging environments may be established between these resource agents to enable allocations to be communicated between the several resource agents to maintain synchronization between the resource agents and to allow the resource agents to delegate resource requests to other resource agents with greater availability or capacity. To prevent the drawings from becoming too complicated, only one resource agent has been shown in each domain 12, 12′. The invention is not limited in this manner, however, as additional resource agents may be provided as well. Each resource agent may be associated with all network elements in the domain, with a subset of network elements in the domain, with particular types of network elements in the domain, or may be allocated network elements on another basis, depending on the desired topography of the network.

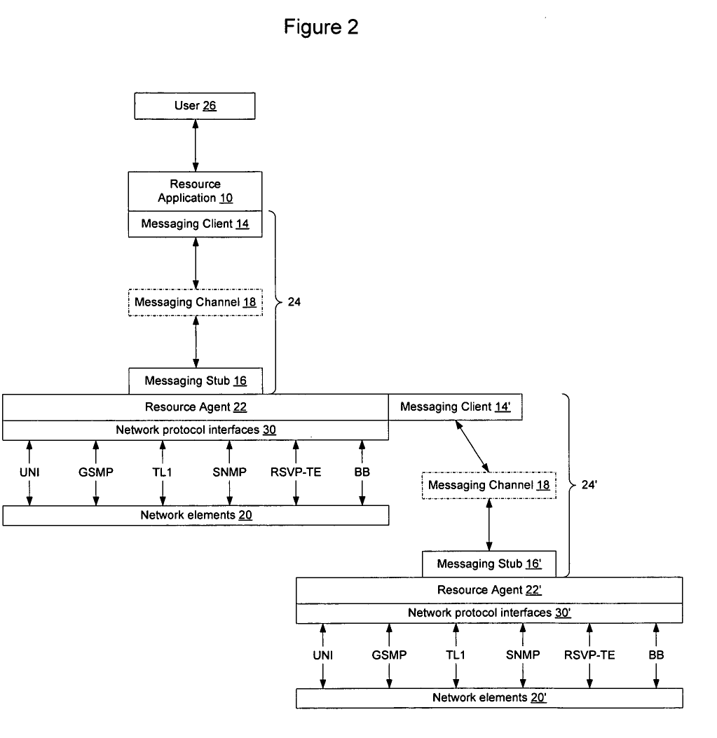

FIG. 2 illustrates a messaging environment 24 created between a resource application 10 and resource agent 22 to enable network resources provided by network elements 20 to be discovered by and obtained for the resource application. As shown in FIG. 2, when a resource application, optionally interfacing a network user 26, requires access to network resources, the resource application will establish a messaging session over the messaging environment 24 by instantiating an instance of a messaging client 14. The messaging client establishes a messaging channel 18 to a messaging server, referred to herein as a messaging stub 16, associated with a resource agent 22. As discussed above, where the resource agent 22 requires access to network resources not under it's control, it may establish one or more additional messaging environments 24′ with other resource agents 22′ by instantiating one or more messaging clients 14′ configured to interface with messaging stubs 16′ associated with the other resource agents 22′. The invention is not limited in this manner, however.

The messaging channel may be implemented using a Transport Control Protocol (TCP) stream socket, an Hyper Text Transfer Protocol (HTTP) session, or an enhanced XML communication such as Simple Object Access Protocol (SOAP), Data Web Transfer Protocol (DWTP) or another conventional protocol. Communications on the messaging channel may be secured using a secure communication protocol such as Transport Layer Security (TLS) or Secure Socket Layer (SSL), or a secure XML messaging protocol such as SOAP with XML signatures and encryption. Additionally, the messages may be configured to contain the identities of the applications and network agents, optionally digitally signed by the applications and agents or containing a certificate provided by the agents or applications, to ensure that the communications have not be altered during transmission. Other forms of security may be implemented as well and the invention is not limited to an embodiment that implements this particular security scheme. For example, the messaging channel between the messaging client and messaging stub may be established using a public key exchange protocol such as Internet Key Exchange version two (IKEv2) or an equivalent, although the invention is not limited in this manner as numerous. procedures may be used to exchange keys or otherwise allow the participants to authenticate the communication channel.

The resource agent, as discussed in greater detail in U.S. patent application Ser. No. 10/719,225, is configured to perform network topology discovery, consolidation, route creation, path allocation, and scheduling, as well as other functions, and to ascertain availability of network resources and effect reservation of those network resources. The resource agent may be extended with the messaging stub, according to one embodiment of this invention. The resource agent has access to network protocol interfaces 30 to allow it to communicate with network elements 20 using one or more network communications protocols when applicable. Examples of protocols that may be used with conventional networks include:
User to Network Interface (UNI), a protocol developed to interface Customer Premises Equipment (CPE) such as ATM switches and optical cross connects with public network equipment;
General Switch Management Protocol (GSMP), a general Internet Engineering Task Force (IETF) protocol configured to control network switches;
Transaction Language 1 (TL1), a telecommunications management protocol used extensively to manage SONET and optical network devices;
Simple Network Management Protocol (SNMP), an IETF network monitoring and control protocol used extensively to monitor and adjust Management Information Base (MIB) values on network devices such as routers and switches;
Resource Reservation Protocol—Traffic Engineering (RSVP-TE), a signaling protocol used in Multi-Protocol Label Switching (MPLS) networks, that allows routers on the MPLS network to request specific quality of service from the network for particular flows, as provisioned by a network operator; and
Bandwidth Broker, an Internet2 bandwidth signaling protocol.
   Other conventional, proprietary protocols, or to be developed protocols may be used as well, and the invention is not limited to these particular identified protocols. The resource agent 22 may effect reservations of resources on a switched underlay network, packet-based statistically multiplexed network, or other type of network. The resource agent 22 may also provide information about the networks in addition to or instead of performing resource allocations. The invention is not limited to particular actions that may be taken on the underlying network.

The resource agent can serve multiple resource requests from multiple resource applications at the same time. The resource agent returns inquiry results and reservation information as a resource response for each resource request. A resource agent can be implemented at a network management station, as a network service, or as a network process in the network control plane. The resource application can be an user end application, a middleware agent, a resource broker, or another resource agent. The invention is not limited to the type of resource agent or resource application chosen to exploit the messaging environment described herein.

The messaging stub 16 and resource agent 22 can be instantiated in many forms on the network. Optionally, the messaging stub and resource agent may be implemented as a stand-alone Web Service, or as a Web Services configured to interact with other Web Services, although the invention is not limited to this environment. For example, the messaging stub 16 may be a web service configured as a server to host sessions with messaging clients, and configured as a web service to interact with resource agents. In one embodiment, the messaging stub and resource agents are instantiated using the Globus Toolkit, such that components are configured with Open Grid Services Interface (OGSI) compliant application interfaces within the Open Grid Services Architecture (OGSA). The invention is not limited to this embodiment, however, as the messaging stub and resource agents may be instantiated in other ways on the network. The messaging stub 16 and resource agent 22 may be collocated on a network element on the communication network or may be instantiated on separate network elements and communicate using a proprietary or open forum protocol. The invention is not limited to the manner in which the messaging stub is instantiated on the network relative to the resource agent, although in a preferred embodiment the two components are tightly integrated to avoid security or other communication lapses between the two components. A given messaging stub 16 may thus serve one or more resource agents 22.

According to an embodiment of the invention, the messaging environment is configured to implement a flexible and secure messaging mechanism between user applications and network elements. The messaging environment, according to one embodiment of the invention, may be implemented as an XML-based messaging mechanism with XML-based resource semantics through which applications can send request messages for network resource reservations and network discovery queries, and through which networks send response messages back to the applications. By causing the message context to be defined by XML, a network resource can be represented by an XML element in the resource schema. As a result, adding new XML elements to the resource schema can easily allow new network resources and services to be made available to applications without requiring the applications to be modified to take advantage of the new resources or services. Similarly, removing old XML elements from the resource XML schemas can delete outdated network resources and services as the networks evolve and as services and resources are phased out.

The actual communication between user applications and network elements may include resource requests and responses. User applications send their resource requests in terms of resource request messages while network elements (through resource agents) send their resource feedback in terms of resource response messages. These messages are formatted and must be consistent with the resource XML schemas so that they can be understood by the two resource peers.

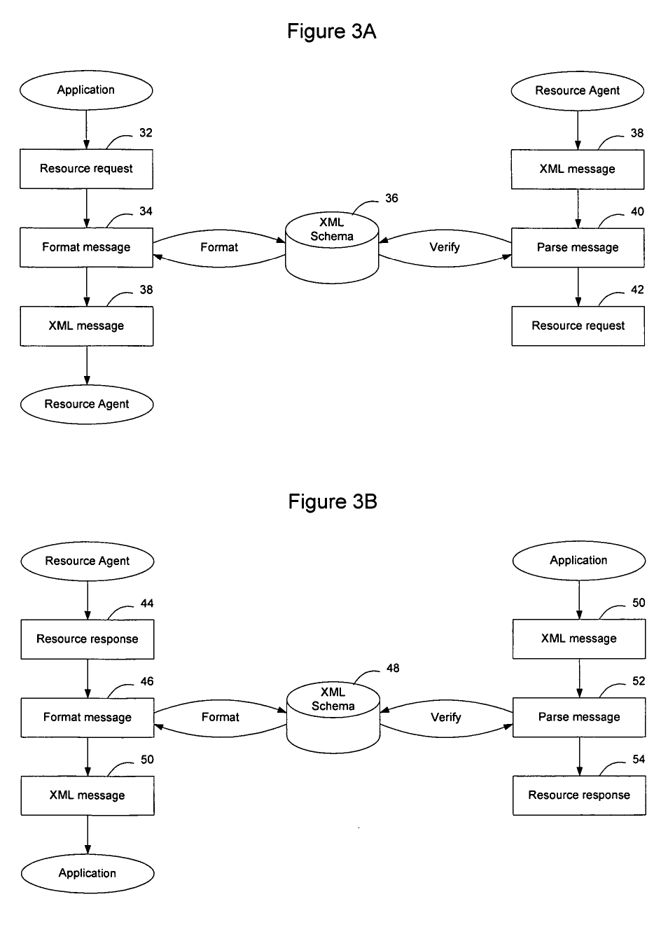

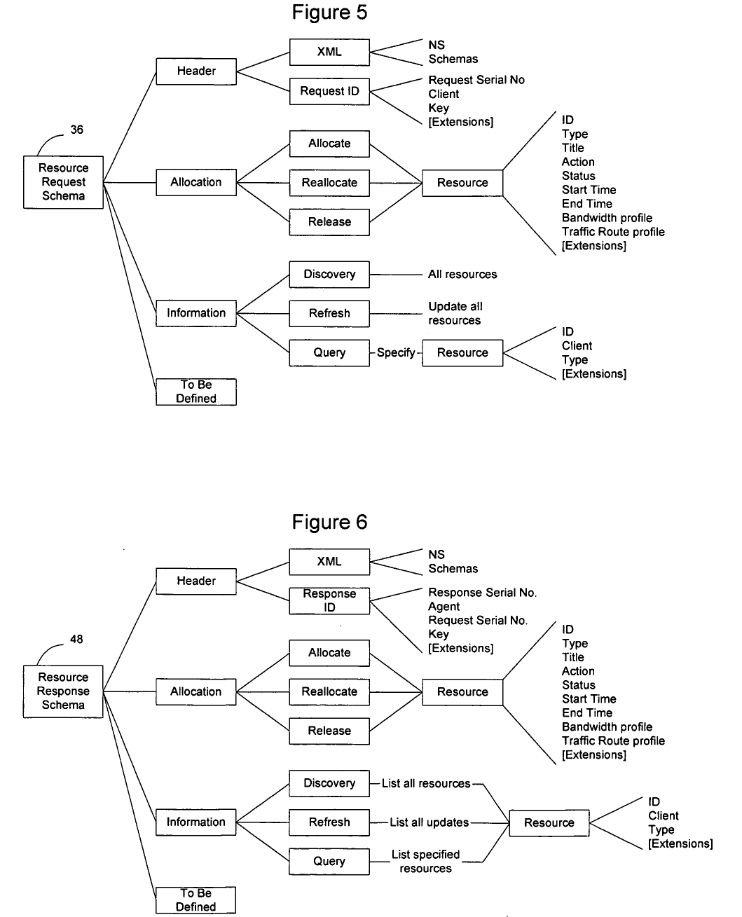

FIGS. 3A and 3B illustrate an XML process for exchanging a resource request message between a resource application and a resource agent, and an XML process for exchanging a resource response between a resource agent and a resource application. Similar processes could be used to exchange other XML messages and the invention is not limited to the use of these two particular messages or processes. As shown in FIG. 3, when an application (optionally interfaced by a user) submits a resource request 32, the message is formatted 34 using an XML schema 36 which outlines the message context of resources. The XML schema 36 defines available fields in an XML document that may be made available to the resource application, and also is used to format the message for transmission over the messaging environment 18. One XML schema that may be used is discussed in greater detail below in connection with FIG. 5. The formatted message is an XML message 38 which may be transmitted to the resource agent.

The resource agent, upon receipt of the XML message 38, parses the XML message 40 using the XML schema 36 to verify the definition of fields in the XML message to extract operable information from the resource request 42. The same procedure is followed to generate a resource response, as shown in FIG. 3B, except that the resource agent generates the resource response 44, which is formatted 46 using a schema 48. One XML schema that may be used is discussed in greater detail below in connection with FIG. 6. The formatted XML message 50 is transmitted over the messaging environment, parsed 52 using the XML schema 48 to verify the definitions of the fields in the document, and to extract the resource response 54. The manner in which an XML document may be created, formatted, and parsed is well known and thus will not be explained in greater detail herein.

As discussed above, messages carried on the messaging channel 18 are defined by the resource XML schemas. Thus, adding or deleting XML elements in the XML schemas can add or delete network resources and services to affect the availability of those services on the network. This enables the messaging environment to be extensible to accommodate new resources and services without requiring applications to be modified to take advantage of the new services. Additionally, new types of resource messaging operations can also be added or deleted by XML schema updates. Thus, not only can the messaging change with time, but new types of messaging can be added simply by adding new schemas that may then be used by the applications to take advantage of the new messaging abilities. XML schema updates may be provided by the resource agent or a third party, and the invention is not limited to the particular manner in which the XML schema is updated.

FIG. 4 illustrates a message format according to an embodiment of the invention. As shown in FIG. 4, the message format outlines the context of each message in terms of XML elements, and generally includes a generic header 60, a messaging header 62, and resource data 64. The generic header provides XML-related information such as version and coding information, similar to the header in any XML document. The messaging header provides messaging channel specific information such as message type, namespaces, Uniform Resource Identifier (URI) definitions, and schema locations. The messaging header may include additional security information such as message serial numbers, source and destination, personal identification and public key information. The resource data contains detailed parameters about the resource request or resource feedback. From the perspective of XML documentation, the messaging header is the top XML element while the resource data provides concrete XML elements. Several examples of particular schemas that may be used to create requests and responses are discussed in greater detail below in connection with FIGS. 5 and 6.

A resource request may be used to obtain a network resource allocation, to obtain information about the network, and for other operations. A resource application may use a network resource allocation request to reserve a particular allocation of network resources and/or services, to modify or release a previous reservation, or for many other purposes. The resource application may use a network information query request to obtain general information about the network, to find out what resources and services are available to it, and to query a particular network resource or service that it wants to use. Correspondingly, a resource agent may return a resource response with a network resource allocation, information, query results, and other results.

FIGS. 5 and 6 illustrate several XML schemas of network resources that may be used to define XML messages in the messaging environment discussed above. A major element in the schema is “Resource”, which represents a network resource. In the schemas, the resource element is outlined with some generic fields and can be extended for particular resources such as bandwidth, traffic route, VPN and so on. Each resource may have its own schema, which is therefore referenced as a resource element in the fundamental resource XML schemas The invention is not limited to these particular schemas, however, since the schemas may change depending on the type of resources to be provided, the particular requirements of the implementation, and numerous other factors. Thus, the embodiments illustrated in FIGS. 5 and 6 are to be understood to be examples only, and not limiting of the invention.

As shown in FIG. 5, a resource request XML schema 36 may include a header field, an allocation field, an information field, and optionally other additional fields to enable resource requests to be created for transmission over the messaging environment 24. The header field may include an XML tag specifying the schema version number and a request ID tag enabling the inclusion of information specific to the request that may be used to distinguish the request from other requests. Examples of such information may include the request serial number, client identification and/or client certificates or signatures, and other information that may be used to differentiate the request from other requests.

The request schema includes an allocation field which indicates the type of action to be performed, and may be used by a request if the request is intended to affect the allocation of network resources. For example, the allocation field may contain an allocate tag indicating that resources should be allocated to the client, a re-allocate tag indicating that resources should be allocated in a different manner, or a release tag indicating that allocated resources are not required and should be released. Other tags may be used as well and the invention is not limited to these particular tags.

In addition to the allocation tags, the allocation field may include resource specific allocation information indicative of the types of resources to be allocated/affected by the request. For example, the allocation information may include an identification of particular resources, the resource type, resource name or title, the action to be performed, the status of the application or resource to be affected, the start time of the requested allocation, the end time of the allocation, the bandwidth profile desired for the intended allocation, the type of traffic route desired for the allocation, and many other types of allocation specific information. The invention is not limited to the particular types of allocation information that may be provided using the allocation field.

The request schema also includes an information field that may be used to obtain information about the network resources from the resource agent. For example, the information field may include a discovery tag to enable the resource request to be used to discover available network resources, a refresh tag to enable the resource request to be used to update its list of available resources, and a query tag to enable the resource request to be used to query the availability or status of specific identified network resources. Since the query tag is directed to specific resources, the schema enables additional information to be included to allow specific resources to be identified. For example, the query information may include resource identification information, client information, or resource type information, although the invention is not limited to these particular types of query information.

FIG. 6 illustrates a resource response XML schema 48 that may be used to create responses to requests from messaging clients, or may otherwise be used to distribute information over the messaging channel 18. For example, the response messages may be used for the periodic transmission of information and are not limited to only be used to respond to request messages. In the embodiment illustrated in FIG. 6, the resource response schema includes a header field, an allocation field, and an information field, which may be selectively used in operation depending on the type of response to be created. Specifically, the response may be an allocation response including allocation information or an information response containing information about the network. Optionally, both types of information may be contained in the same response; for example a response may contain information about all routers available on the network and an allocation of bandwidth through a particular subset of the routers. Alternatively, two responses may be provided where more than one type of response is appropriate.

The header field may enable information to be included to enable the XML message to be parsed, and may include items such as the schema version that was used to generate the response and the location of the schema, to enable the XML parser to correctly parse the XML response. The header field may also enable a response ID tag to be included to enable the response to be identifiable to the messaging client. For example, the response ID tag may allow response identification information to be included, such as the response serial number, the request serial number to which the response pertains, the agent identification information, and any required agent key information such as certificates or signatures to enable the response to be verified to the messaging client and/or application. Fields for other types of information may be included as well as desired.

The response schema includes an allocation field configured to contain allocation tags such as an allocate tag, a reallocate tag, and a release tag indicative of the particular resources to be allocated, reallocated, or released on the network. In addition, the schema may enable the allocation tags to specify additional information about the resources, such as the resource identification, the type of resource, the title of the resource if it has a common name, the action to be performed on the resource, the current status of the resource, the start and end times associated with the resource allocation, the bandwidth profile associated with the resources, and the traffic route profile. Tags for other information may be provided as well, and the invention is not limited to a schema including tags for these particular types of resource allocation information. For example, the schema may be developed to enable the allocation of particular VPN resources or to enable usage information, such as label information or required header information, to be passed using resource response messages in connection with the allocation information.

The response schema also includes an information field containing one or more tags which may be used to transmit network resource information to the resource client. For example, the information field may include a discover tag enabling a list of all resources to be provided, a refresh tag enabling a list of updated resources to be provided, and a query response enabling a list of resources to be provided in response to a particular resource query. The resources may be identified by resource ID, client ID, type, or in another manner, and the invention is not limited to the manner in which the schema is configured to identify the resources.

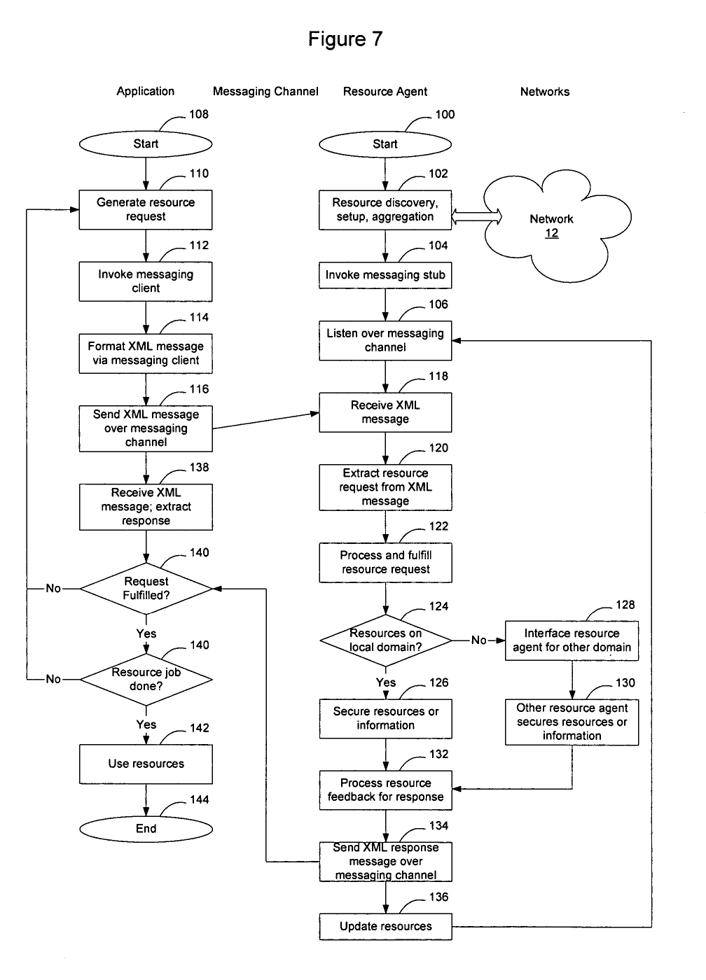

FIG. 7 illustrates a method of using the extensible messaging environment described above in connection with FIGS. 1-6. As shown in FIG. 7, initially, a resource agent will be started on the network (100) and perform whatever resource discovery, setup, aggregation, and other operations are required or desirable (102) to enable the resource agent to interface with the network 12 and secure desired resources or information from the network 12. Once the resource agent has completed its initialization process, it will invoke a messaging stub (104) which will begin to listen over the messaging channel (106) for resource requests from messaging clients. Although the process so far has assumed the resource agent will be started before the messaging stub is started, the invention is not limited in this manner as the messaging stub may be started initially, and may then interface with instantiated resource agents or cause necessary resource agents to be started. The invention is thus not limited to the particular manner in which the messaging stub and resource agent are initialized or the manner in which they are associated.

Once the messaging channel is established, such that the messaging stub is listening on the messaging channel, resource applications may make requests over the messaging channel for access to network resources or for information about the underlying networks (108). To do so, the application will generate a resource request (110) and invoke a messaging client (112). The resource request will be formatted into an XML message using the messaging client in a manner as discussed above in connection with FIG. 3A (114) and the formatted XML message will be sent over the messaging channel to the messaging stub (116).

When the messaging stub receives the XML message (118) it will extract the resource request from the XML message using the procedure discussed above in connection with FIG. 3A (120) and pass the resource request to the resource agent to be processed and fulfilled (122). In connection with this, either the resource agent or the resource stub will make a determination whether the resources are on a local domain under the control of the resource agent or whether the resource request requires access to other resources (124). If all the resources are available on the local domain, the resource agent will secure the resources or information (126). If not, one or more resource agents for other domains will be accessed (128) to enable the other resource agent(s) to secure the resources or information (130). A subservient messaging environment may be spawned to interface with the other resource agents as discussed in greater detail above.

Interfacing between domains may occur in many different ways. In one embodiment, the messaging stub is configured to interface with a particular resource agent, and may cause that resource agent to interface other resource agents as necessary. In another embodiment, the messaging stub is provided with direct access to multiple resource agents and may interface with these resource agents directly. The invention is not limited to the manner in which inter-domain resources are obtained.

Once the resources have been obtained, the resource responses from the resource agent(s) are processed to generate one or more resource responses, as discussed in greater detail above in connection with FIG. 3B (132). The XML response is then sent over the messaging channel (134) and, if resources have been allocated during this process, any necessary tables associated with the resource agent may be updated to reflect the allocation (136).

The resource application, upon sending a resource request over the messaging channel, will listen on the messaging channel for a resource response message. Upon receipt of a resource response message, the resource application will extract the resource response using the process described above in connection with FIG. 3B (138) and determine if the requested resources have been allocated or if the requested information has been provided (139). If the resource response did not provide the requested resources or if additional resources are otherwise required, the resource application may optionally generate a second request and the process may iterate until sufficient resources are obtained. Alternatively, the process may end at this point. If the resources have been allocated, or resource information provided (140), the resource application uses the resources 142 in a conventional manner and the process ends until additional resources are required.

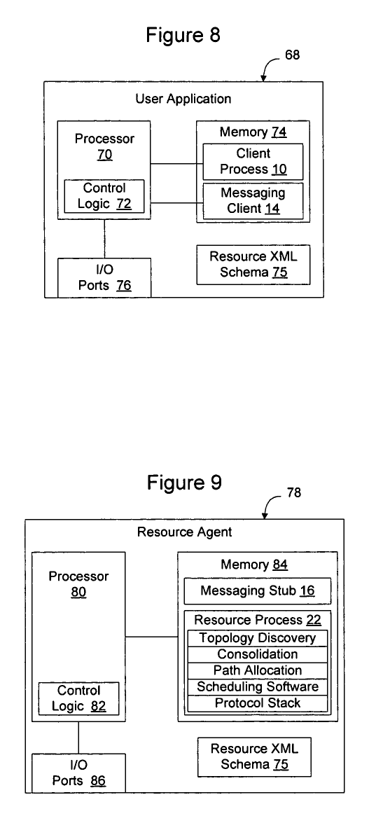

FIGS. 8 and 9 illustrate embodiments of network elements configured to respectively implement a user application, including a messaging client, and a resource agent, including a messaging stub, according to embodiments of the invention. Each of these embodiments will be discussed in greater detail below.

As shown in FIG. 8, a user application may be instantiated on a network element 68 including a processor 70 having control logic 72 configured to implement the functions ascribed to the client process 10 and messaging client 14 discussed herein in connection with FIGS. 1-7. The network element implementing the user application has a native or interfaced memory 74 containing data and instructions to enable the processor to implement the functions ascribed to it herein. For example, the memory may contain software modules configured to perform functions associated with the resource application 10 and the messaging client 14, as well as optionally other modules to enable the network element to participate in transactions over the messaging channel 18. For example, the messaging client may have access to one or more XML schemas of network resources 75 to allow it to generate resource requests and parse resource responses. The invention is not limited to the embodiment illustrated herein as the resource application and messaging client may be instantiated on separate network elements, if desired. One or more I/O ports 76 may be provided to enable the network elements to communicate on the network, and optionally additional functional modules may be provided to enable the network element to perform additional services on the network.

FIG. 9 illustrates a resource agent according to an embodiment of the invention. As shown in FIG. 9, a resource agent may be instantiated on a network element 78 including a processor 80 having control logic 82 configured to implement the functions ascribed to the messaging stub 16 and processes associated with the resource agent 22 discussed herein in connection with FIGS. 1-7. The network element has a native or interfaced memory 84 containing data and instructions to enable the processor to implement the functions ascribed to it herein. For example, the memory may contain software modules configured to perform functions associated with the messaging stub 16 and resource agent 22, as well as optionally other modules to enable the network element to participate in transactions over the messaging channel 18. For example, the messaging stub may have access to one or more XML schemas 75 of network resources to allow it to interpret resource requests and to generate resource responses. The invention is not limited to the embodiment illustrated herein as the resource application and messaging client may be instantiated on separate network elements, if desired. One or more I/O ports 86 may be provided to enable the network elements to communicate on the network, and optionally additional functional modules may be provided to enable the network element to perform additional services on the network.

It should be understood that all functional statements made herein describing the functions to be performed by the methods of the invention may be performed by software programs implemented utilizing subroutines and other programming techniques known to those of ordinary skill in the art. Alternatively, the functions may be implemented in hardware, firmware, or a combination of hardware, software, and firmware. The invention is thus not limited to a particular implementation.

The control logic 72, 82, may be implemented as a set of program instructions that are stored in a computer readable memory within the network element and executed on a microprocessor, such as processor 70, 80. However, in this embodiment as with the previous embodiments, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of messaging between an application and network elements in a communication network, the method comprising the steps of:
instantiating a messaging client associated with the application;
generating by the messaging client an XML document using an XML schema containing tags indicative of resources required by the application; and
transmitting the XML document over a messaging channel to a messaging stub associated with the communication network.

2. The method of claim 1, wherein the messaging stub is associated with a resource agent configured to interface network elements on the communication network.

3. The method of claim 1, wherein the resources required by the application comprise bandwidth on the communication network.

4. The method of claim 1, wherein the resources required by the application comprise VPN resources on the communication network.

5. The method of claim 1, wherein. the resources required by the application comprise information relating to the available network resources on the communication network.

6. The method of claim 1, wherein the messaging channel is a secure messaging channel.

7. The method of claim 6, wherein the secure messaging channel is provided using at least one of authentication and digital signatures.

8. The method of claim 1, wherein the XML document defies network operations.

9. The method of claim 8, wherein the operations comprise at least one of discovery, status updates, information, and allocations.

10. The method of claim 1, wherein the XML schema allows network resources to be expressed as resource specific XML elements.

11. The method of claim 1, wherein the transmitted XML document is a request message, the method further comprising the step of receiving a response message related to the request message.

12. The method of claim 11, wherein the response message and the request message share a common format.

13. The method of claim 1, further comprising the step of instantiating a second messaging client associated with the messaging stub to enable the messaging stub to establish a second messaging channel to obtain at least a portion of the resources required by the application.

14. The method of claim 13, wherein the messaging stub is associated with a first network domain, and wherein tile portion of the resources are associated with a second network domain.

15. An XML schema configured to enable network resources to be requested on a communications network, the XML schema comprising:
a header field configured to enable a request created using the schema to include identifying information; and
an allocation field configured to enable the request created using the schema to include a request for allocation of network resources.

16. The XML schema of claim 15, wherein the allocation field allows network resources to be expressed as resource specific XML elements.

17. The XML schema of claim 15, wherein the resources are virtual private network (VPN) resources.

18. The XML schema of claim 15, wherein the header field includes an XML tag configured to enable identification of the XML schema used to create the request, and a request ID tag configured to enable identifying information to be input into the request.

19. The XML schema of claim 15, wherein the allocation field contains tags configured to enable the request to specify resources to be allocated, reallocated, and released.

20. The XML schema of claim 19, wherein the resources may be specified using at least one of resource ID, resource type, resource name, and wherein the request may include resource parameters comprising at least one of a bandwidth profile, a traffic route profile, a start time and an end time.

21. The XML schema of claim 15, wherein the XLM schema further comprises an information field configured to enable the request created using the schema to include a request for information about network resources.

22. The XML schema of claim 21, wherein the information field includes at least one of a discovery tag that may be used to discover network resources, a refresh tag that may be used to update a list of network resources, and a query tag that may be used to inquire as to particular identified network resources.

23. One or more processor readable storage devices having processor readable code embodied thereon, said processor readable code being configured to program one or more processors to create a response message using an XML schema configured to enable network resource semantics to be expressed as resource specific XML elements,

24. The one or more processor readable storage devices of claim 23, wherein the XML schema includes a header field configured to enable the response message created using the schema to include identifying information, and an allocation field configured to enable the response message created using the schema to include information associated with an allocation of network resources.

25. The one or more processor readable storage devices of claim 24, wherein the header field includes an XML tag configured to enable identification of the XML schema used to create the response, and an ID tag configured to enable the request to include identifying information about an associated request

26. The one or more processor readable storage devices of claim 24, wherein the information associated with the allocation of network resources comprises at least one of resource ID, resource type, and resource name, and wherein the response may further include resource parameters comprising at least one of a bandwidth profile, a traffic route profile, a start time and an end time,

27. The one or more processor readable storage devices of claim 24, wherein the XLM schema includes an information field configured to enable the response to include information about network resources.
